(19) United States
(12) Patent Application Publication
(10) Pub. No.: US 2018/0215673 A1
(43) Pub. Date: Aug. 2, 2018

(54) PROCESS FOR CREATING PATTERNS ON THE SURFACE OF A COMPOSITION BASED ON HYDRAULIC BINDER BY PRINTING

(71) Applicant: CHRYSO, ISSY LES MOULINEAUX (FR)

(72) Inventors: Mathias AGNELY, BOURG-LA-REINE (FR); Sandrine MATEO, URY (FR); Bruno PELLERIN, AVON (FR)

(21) Appl. No.: 15/749,081

(22) PCT Filed: Jul. 28, 2016
(86) PCT No.: PCT/EP2016/068075

§ 371 Date: Feb. 8, 2018

(30) Foreign Application Priority Data
Jul. 31, 2015 (FR) 15 57420

(51) Int. Cl. C04B 41/00; C04B 41/45; C04B 41/50; C04B 41/53; C04B 41/72; C04B 28/02

(52) U.S. Cl. CPC C04B 41/009; C04B 41/4578; C04B 41/5016; B28B 11/048; C04B 41/5323; C04B 41/72; C04B 28/02; C04B 41/4572

(57) ABSTRACT

The application relates to a method for creating a pattern on a surface of a hydraulic binder-based composition, comprising applying by printing a deactivating composition (D1) or acidic composition (A1) to a part or to the whole surface of a hydraulic binder-based composition.

The present invention relates to a method for creating patterns on a surface of a hydraulic binder-based composition, especially concrete, by printing.

Concrete is a building material used in the manufacture of elements that may have very different shapes and aspects.

Deactivated concrete, whose aggregates are visible, allows, in particular, a wide range of aspects and colors to be obtained. It is found on building sites (sidewalks, squares, car parks, courtyards, promenades . . . ) but also in the manufacture of street furniture (planters, garbage cans . . . ), gravel slabs or wall panels.

The final appearance of deactivated concrete depends mainly on its composition. In particular, the aggregates used may be of different sizes, shapes and colors (white marble, red rock . . . ). In addition, the color of the cement may add a specific nuance, since it may be chosen to be gray, white or dyed by a dye.

The production of deactivated concrete requires the application of an agent to the concrete surface to delay the setting of the concrete surface. This agent is generally called a “surface deactivator” or “surface setting retarder”.

When it is desired to produce large-area molded parts or parts whose deactivated surface is not in contact with the mold, for example parts intended to form flooring, the deactivating agent is sprayed on the surface of the concrete after its laying and trowelling. When used in this way, the deactivating agent is called a “positive deactivator”.

Upon contact with the surface of a composition based on fresh hydraulic binder, the surface deactivator penetrates to a certain depth through diffusion and induces setting retardation. The uncured hydraulic binder layer on the surface remains brittle and may be removed. The objective is to make the aggregates appear on the surface. The depth of the layer retarded by the deactivating composition, also called hollowing force or etching force, is essentially chosen as a function of the size of the aggregates used. The objective is to make the aggregates appear on the surface, so the hollowing force depends on the aesthetic effect desired, as well as the size of the aggregates. The deactivating composition is chosen according to the desired effect; typically the larger the aggregates, the greater is the need for the composition to have a significant hollowing force.

It may be interesting, for aesthetic reasons, to inscribe elements in the concrete, i.e. to have a method for creating patterns on the concrete surface.

According to a first alternative, these patterns may be created by deactivating the desired areas of the surface of a composition based on fresh hydraulic binder.

Patent application EP 1 177 081 describes a method for creating a concrete coating having patterns with the aid of a deactivating agent transferred to a surface in contact with the concrete to be molded by means of a printing technique. In this document, the deactivating agent is placed on a surface to be positioned in contact with the concrete, but not on the surface of the concrete itself. In one embodiment, the surface is a membrane on which patterns have been printed using the deactivating agent as ink. The membrane is deposited at the bottom of the mold in which the concrete will be poured. It is therefore necessary to prepare or buy a printed membrane. In addition, once used, the membrane becomes waste to be disposed of. In another embodiment, this surface is the mold into which the concrete is poured. Thus, the desired patterns comprising the deactivating agent are printed directly at the bottom of the mold. This embodiment is however only applicable to molded parts.

Patent application WO 2014/006102 discloses a method for creating a pattern on a surface of a hydraulic binder composition, involving depositing a stencil on the surface of the fresh hydraulic binder composition and then applying a deactivating composition (D1) on the surface thus covered. Again, it is necessary to prepare or buy a stencil, and the stencil becomes waste to be disposed of.

According to a second alternative, these patterns may be created by acid etching of the desired areas of the surface of a hardened hydraulic binder composition.

Patent application US 2010/0313519 describes a method for creating a non-slip hydraulic binder-based composition surface, wherein one of the steps is the application of an acidic solution on the surface to be hollowed and so render the aggregate visible. The acidic solution is applied by a sprinkler system or sprayer. However, the application of the acidic solution to a localized part of the surface in order to reveal patterns on the surface is not suggested. The surface may contain patterns, but these are created by making cuts in the composition based on fresh hydraulic binder, and whose geometry corresponds to the desired patterns.

The development of a method for creating patterns on the surface of a concrete of a part that may be molded or not, and that does not require a membrane or stencil is therefore required.

To this end, the invention relates to a method for creating patterns on a surface of a composition based on a hydraulic binder, comprising applying by printing a deactivating composition (D1) or acidic composition (A1) on part or all of a surface of hydraulic binder-based composition.

Advantageously, the hydraulic binder-based composition used in the method according to the invention may be in the form of a molded part or an unmolded part.

In addition, the method according to the invention does not require a stencil or membrane. There is therefore no prior step of preparing a stencil or a printed membrane. In addition, once the method is implemented, there is no waste to be disposed of.

Advantageously, the method provides access to an unlimited number of pattern shapes as well as patterns having complex shapes.

The method may be used for any type of hydraulic binder-based composition, and regardless of the shape of the part formed by the hydraulic binder-based composition, including for a part whose surface to be deactivated is not flat, as detailed below.

The term “hydraulic binder” is understood to mean any compound having the property of hydrating in the presence of water and whose hydration makes it possible to obtain a solid having mechanical characteristics. The hydraulic binder may comprise or consist of a cement according to the standard EN 197-1 and, in particular, a cement of the CEM I, CEM II, CEM III, CEM IV or CEM V type according to the French cement standard EN 197-1 (2012). In particular, the cement may therefore comprise mineral additions.

The term “composition based on hydraulic binder” means a composition comprising a hydraulic binder. It may be a hydraulic binder-based composition, which then corresponds to a “hydraulic binder composition”, or a composition based on hardened hydraulic binder, such as a concrete.

The term “fresh” refers to hydraulic binder-based compositions when they have been tempered with water, but have not yet hardened. The composition is then malleable enough to fill the mold or formwork.

The term “hardened” is understood to mean such hydraulic binder-based compositions when they are hardened.

By the term “setting” is meant the transition to the solid state by hydration reaction of the binder.

By the term “concrete” is meant a mixture of hydraulic binders, aggregates, sands, water, optionally additives, and possibly mineral additions. The term “concrete” also includes mortars and screeds.

The term “mineral additions” refers to slags (as defined in the French Cement Standard EN 197-1 (2012) section 5.2.2), steelmaking slags, pozzolanic materials (as defined in French Cement Standard EN 197-1 paragraph 5.2.3), fly ash (as defined in French Cement Standard EN 197-1 paragraph 5.2.4), calcined schists (as defined in French Cement Standard EN 197-1 paragraph 5.2.5), limestones (as defined in French Cement Standard EN 197-1 paragraph 5.2.6), or even fumes of silicas (as defined in French Cement Standard NF EN 197-1, paragraph 5.2.7) or their mixtures. Other additions, not currently recognized by the French Cement Standard EN 197-1 (2012), may also be used. In particular, these include metakaolins, such as type A metakaolins conforming to French standard P 18-513, and siliceous additions, such as the siliceous additions of mineralogy Qz in accordance with the French standard P 18-509 (2012).

By the term “aggregates” is meant a set of mineral grains of average diameter between 0 and 125 mm. Depending on their diameter, aggregates are classified into one of six families: fillers, sand, gravels, chippings and ballast (standard XP P 18-545 of September 2011). The most widely used aggregates are: fillers, which have a diameter of less than 2 mm and for which at least 85% of the aggregates have a diameter of less than 1.25 mm and at least 70% of the aggregates have a diameter less than 0.063 mm, sands with a diameter between 0 and 4 mm (diameter up to 6 mm in standard 13-242), gravels with a diameter greater than 6.3 mm, chipping diameters between 2 and mm and 63 mm. Sands are therefore included in the definition of aggregates according to the invention. The fillers may in particular be of calcareous, siliceous or dolomitic origin.

In the method according to the invention, a deactivating composition (D1) or acidic composition (A1) is applied to part or all of a surface of the hydraulic binder composition by printing. Both the deactivating composition (D1) and the acidic composition (A1) applied by printing are capable of etching/hollowing the hydraulic binder composition to form patterns. In the method according to the invention, the patterns are created by removing a portion of the hydraulic binder composition. Patterns are not created by adding material to the hydraulic binder composition.

Preferably, the deactivating composition (D1) or acidic composition (A1) is applied to a part of the surface of the hydraulic binder composition.

If a repeated pattern is produced, for example on an aisle, the application step may be effected by printing a deactivating composition (D1) or acidic composition (A1) on a first part of the surface of the hydraulic binder-based composition, and then this step is repeated for each part, which allows the creation of each pattern of the aisle one after the other. Typically, the printing is located where a pattern is desired and then, after printing, it is moved to the next location where a pattern is desired, and then repeated as many times as necessary.

In the method according to the invention, the deactivating composition (D1) or acidic composition (A1) is applied by printing. Typically, this composition is the printing ink.

Preferably in the method according to the invention, the printing is performed by an ink jet printer. For example, a PolyJet printer (from the company Stratasys) may be used. The print head of the inkjet printer expels a jet or droplets of deactivating composition (D1) (or possibly of another deactivating composition, for example a deactivating composition (D2) or (D3) as described below), or an acidic composition (A1) (or optionally another acidic composition, for example an acidic composition (A2) or (A3) as described below). The jet forms dots on the surface of the hydraulic binder composition. The patterns are formed by dot concentrations.

Advantageously, with an inkjet printer, the diameter of the expelled jet/droplets may be controlled, which makes it possible to control the resolution of the printing, the amount of deactivating composition (D1) or acidic composition (A1) deposited at a given location on the surface, and thus hollowing at a given location. The larger the diameter of the expelled jet/droplets, the worse is the fineness of the details obtained, but the faster is the treatment of a given surface.

By “hollowing” is meant the difference in height between:
the surface of the hydraulic binder-based composition before printing, and
the lowest point on the surface of the hydraulic binder-based composition to which the deactivating composition (D1) has been applied, wherein this point is obtained following the step of removing the unhardened hydraulic binder layer on the surface, or
the lowest point of the surface of the hydraulic binder-based composition to which the acidic composition (A1) has been applied, wherein this point is obtained following the rinsing step of the hardened hydraulic binder-based composition.

The hollowing is understood to refer to a given area of the surface of the hydraulic binder-based composition. In fact, the surface of the hydraulic binder-based composition may have different hollows, as explained below.

The smaller the droplet/jet diameter, the better the definition of the pattern, but the longer the printing. Consequently, the droplet/jet diameter is a compromise between the definition of the patterns, the desired hollowing, and the speed of printing.

The diameter of the expelled droplets may be measured by laser diffraction, for example using a Malvern Spraytec apparatus. Usually, droplets have a diameter measured by laser diffraction between 1 μm and 1000 μm, for example between 2 μm and 500 μm. For example, PolyJet printers (from the company Stratasys) make it possible to obtain these droplet sizes even for viscous liquids. On parts with sides several meters long, the desired precision of the position of the pattern is of the order of a few hundred microns.

In one embodiment, the surface of the hydraulic binder composition is planar. The printing may then be effected with a printer to control the location of the application in two dimensions of the deactivating composition (D1) or acidic composition (A1). The printing is then effected by a conventional printer that allows the application of a controlled amount of printing ink at a point having controlled coordinates (X, Y).

In another embodiment, the surface of the hydraulic binder composition is not planar. The printing may then be effected with a printer to control the location of the application in three dimensions of the deactivating composition (D1) or acidic composition (A1). The printing is then implemented by a printer which makes it possible to apply a controlled quantity of printing ink at a point having controlled coordinates (X, Y, Z). Such an impression is not necessarily “3D printing” in the usual sense of the term, because in this embodiment of the method according to the invention, the application of the deactivating composition (D1) or acidic composition (A1) is not an additive manufacturing method (a new object is not formed). However, printing may be effected by a 3D printer. By “3D printer” is meant a system for the programmed deposition of a quantity of material at a point defined by its coordinates in three spatial dimensions.

According to a first alternative, the method comprises the application by printing of a deactivating composition (D1) on a part or on the whole of a surface of a fresh hydraulic binder-based composition.

The method according to the invention usually comprises, before the step of applying by printing the deactivating composition (D1) on the hydraulic binder-based composition, a step of shaping the fresh hydraulic binder-based composition.

Typically, the shaping is effected by casting, trowelling and, if necessary, vibration.

Air bubbles and/or rings may form on the surface of the fresh hydraulic binder composition. They come from the upwelling of air from the composition based on fresh hydraulic binder. Air bubbles may be very difficult to remove even by smoothing the surface, while they impart an unsightly appearance to the hardened surface. To limit this phenomenon, the fresh hydraulic binder-based composition is advantageously trowelled before application of the deactivating composition (D1). Advantageously, the method according to the invention makes it possible to limit the appearance of unsightly air bubbles or rings on the surface of the hydraulic binder-based composition more than prior art methods using a stencil or a membrane, especially those described above. In fact, in these methods, bubbles may form at the interface between the surface of the fresh hydraulic binder composition and the stencil or membrane.

In a particular embodiment, the shaping of the fresh hydraulic binder-based composition is effected by 3D printing (by an additive manufacturing method). Typically, the method then comprises a step of shaping the fresh hydraulic binder-based composition by a 3D printer, and a step of application by the 3D printer of the deactivating composition (D1) on a part of the surface of the fresh hydraulic binder-based composition. The shaping step and the application step of the deactivating composition (D1) may be successive or simultaneous.

Different levels of deactivation (or hollowing) may be desired for a given pattern. Two embodiments of this first alternative of the method are conceivable to obtain this effect.

According to a first embodiment, the method comprises applying a deactivating composition (D1) by printing on part or all of a surface of a fresh hydraulic binder-based composition, then another application of the deactivating composition (D1) by printing on a part of the surface on which a deactivating composition (D1) has been applied, wherein this additional application may possibly be repeated. This first embodiment makes it possible to apply different amounts of deactivating composition (D1) to different parts of the surface of the fresh hydraulic binder-based composition which it is desired to deactivate. Typically, successive passes of the printhead of the printer are effected on the part(s) of the surface for which deeper hollowing is desired. The greater the amount of deactivating composition (D1), the greater the depth obtained. Thus, to obtain a pattern with two levels of deactivation, the deactivating composition (D1) is applied once on a first part of the surface, and more than once (typically twice) on a second part of the surface. Similarly, to obtain a pattern with three levels of deactivation, the deactivating composition (D1) is applied, for example, once to a first part of the surface, twice to a second part of the surface, and three times to a third part of the surface.

In this first embodiment, the method may comprise an accelerated drying step of the part of the surface on which the other application will be effected between two successive applications of deactivating composition (D1). This drying may be effected under UV or infrared light. It allows faster preparation and a sharper outline of the different levels of the pattern.

According to a second embodiment, the method comprises applying a deactivating composition (D1) by printing on part or all of a surface of a fresh hydraulic binder-based composition, and then applying a deactivating composition (D2) by printing on part or all of the surface of the fresh hydraulic binder-based composition, wherein the deactivating compositions (D1) and (D2) exert different hollowing effects, and are not applied to identical surfaces.

Of course, the fact that the deactivating compositions (D1) and (D2) are not applied to identical surfaces does not exclude the surface on which the deactivating composition (D1) is applied from being included in the surface upon which the deactivating composition (D2) is applied, or vice versa. In addition, the fact that the deactivating compositions (D1) and (D2) are not applied to identical surfaces does not exclude the deactivating compositions (D1) and (D2) from being applied to surfaces that overlap. When the surfaces overlap, a pattern with three levels of deactivation will be obtained: a first part of the pattern with a first level of hollowing on which only the deactivating composition (D1) has been applied, a second part of the pattern with a second level of hollowing on which only the deactivating composition (D2) has been applied, and a third part of the pattern with a third level of hollowing on which the deactivating compositions (D1) and (D2) have been applied.

Of course, as many deactivating compositions with different hollowing effects may be used as desired. Thus, in one embodiment of this second embodiment, the method comprises applying a deactivating composition (D1) by printing on part or all of a surface of a fresh hydraulic binder-based composition, then applying a deactivating composition (D2) by printing on a part or on the entire surface of the fresh hydraulic binder-based composition, and then applying a deactivating composition (D3) by printing on part or all of the surface of the fresh hydraulic binder-based composition, wherein the deactivating compositions (D1), (D2) and (D3) have different hollowing effects and are not applied to identical surfaces.

Typically, each deactivating composition (D1), (D2) and (D3) corresponds to the ink of an ink cartridge of the printer.

The deactivating compositions (D1), (D2) and (D3) comprise a surface-setting retarder. They may be in the form of a solution in an aqueous or oily solvent or in a petroleum fraction, or in the form of a dispersion in an aqueous or oily solvent or in a petroleum fraction, in particular in the form of a suspension or in the form of an emulsion.

In the context of this disclosure, the term “surface-setting retarder” is intended to mean a compound having the effect of retarding the setting of the hydraulic binder-based composition, i.e. of delaying or inhibiting the related phenomena such as hydration phenomena, thereby inducing a later hardening of the composition. In general, a surface-setting retarder delays the setting time of a hydraulic binder-based composition in which it has been introduced at a dosage of at most 5% by dry weight relative to the weight of the hydraulic binder, wherein the setting time is measured according to the EN480-2 (2006) test. Preferably, the setting time is delayed by at least 30 minutes with respect to a control hydraulic binder-based composition.

In the context of the invention, the term “oily solvent” means a solvent comprising fats of vegetable origin, animal or mineral, which may be liquid at room temperature or not. These oils may be recycled or regenerated. However, when they are not liquid at room temperature, the composition is preferably prepared at a temperature at which all its components are liquid.

The vegetable oil may, in particular, be selected from rapeseed oil, palm oil, coconut oil, castor oil, peanut oil, grapeseed oil, corn oil, mayola oil, flaxseed oil, soybean oil, sunflower oil and mixtures thereof.

The animal oils may be chosen, in particular, from tallow, suintine, lard oil, herring oil, cod liver oil, sardine oil, fish oil and lanolin oil, and mixtures thereof.

The mineral oils may, in particular, be aliphatic, paraffinic or naphthenic oils; they include, in particular, fractions comprising on average 8 to 30 carbon atoms, preferably 11 to 25 carbon atoms, alone or as a mixture, in particular light mineral oil. The preferred oils are mineral oils CnH2n+2, where n lies between 8 and 19.

In the context of the present invention, the term “emulsion” denotes both water-in-oil emulsions and oil-in-water emulsions, wherein the oil is chosen, in particular, from among the oils mentioned above.

The retarder of the deactivating composition (D1), (D2) and (D3) used in the method according to the invention is chosen from the compounds known for this purpose.

The surface-setting retarder of the deactivating composition in aqueous solvent may be chosen from compounds known for this purpose, such as carboxylic acids, their salts and their derivatives; carbohydrates, especially sugars, their salts and derivatives; but also lignosulfonic acid, phosphonic acids, in particular those bearing amino or hydroxy groups, their salts and their derivatives; or inorganic acids such as phosphoric acid, their salts and derivatives.

In the context of the present invention, derivatives of carboxylic acids, carbohydrates, lignosulfonic acids, phosphonic acids, in particular those carrying amino or hydroxy groups; and inorganic acids, also including the salts of these derivatives.

The surface-setting retarder of the deactivating composition in aqueous solution is preferably chosen from carboxylic acids, their salts and their derivatives; sugars, their salts and their derivatives; or a mixture thereof.

Among the sugars, the surface-setting retarder of the deactivating composition may be chosen in particular from among glucose, fructose, sucrose, meritose, lactose, maltotriose, dextrose, maltose, galactose, mannose, glycogen or a mixture thereof.

Among the carboxylic acids, mention may be made, in particular, of maleic acid and hydroxycarboxylic acids and among these, in particular, citric acid, tartaric acid, malic acid, gluconic acid, and lactic acid, their salts or a mixture thereof.

Among the carboxylic acid salts, mention may be made of sodium salts, calcium salts or potassium salts. As a particular example, mention may be made of sodium citrate, sodium tartrate or sodium gluconate.

The term “carboxylic acid derivatives” is intended to denote their salts and esters and, by way of a particular example, mention may be made of ethyl acetate.

In the case of hydroxycarboxylic acids, the derivatives include lactones.

The surface-setting retarder of the deactivating composition in oily solution may be chosen from among the compounds known for this purpose, such as those disclosed in patent application EP 2 935 140, in particular the alkyl esters of hydroxy-carboxylic acids which are soluble in oils/solvents, or are dispersible in oils/solvents. It is for example an alkyl ester of citric acid such as triethyl citrate.

The retarder of the deactivating composition used in the emulsions may be chosen from among the aqueous solvent retarders and the oily solvent retarders defined above.

The retarder of the deactivating composition in solution in an emulsion, in particular in an oil-in-water emulsion, may be chosen from among carboxylic or hydroxycarboxylic acids which may comprise a saturated or unsaturated carbon chain and have 1, 2 or 3 hydroxyl groups, while it may also be in the form of a salt, especially sodium salt, potassium salt or calcium salt. The acid is preferably selected from acetic acid, gluconic acid, citric acid, tartaric acid, maleic acid, mixtures thereof, or salts thereof. Particularly preferred are citric acid, malic acid and tartaric acid. In the case of oil-in-water emulsion, the emulsion preferably comprises from 5 to 50% by weight of oily phase, preferably from 10 to 40% by weight and from 50 to 95% by weight of aqueous phase, preferably from 60 to 90%. In the case of an emulsion, the deactivating composition further comprises a surfactant. For oil-in-water emulsions, the surfactant is preferably a non-quaternary amine surfactant. Such oil-in-water emulsions are described in application WO 2012/056162.

The surface-setting retarder of the deactivating composition in solution in the petroleum fractions may be chosen from among the aforementioned retarders for the aqueous or oily phases which are crushed and then dispersed within the petroleum fractions.

The deactivating composition (D1), (D2) or (D3) generally comprises from 0.1 to 20% by weight of surface-setting retarder. Typically, when an ink jet printer is used, the proportions of retarding agent in the deactivating composition (D1), (D2) or (D3) are adapted so that the surface-setting retarder is in a proportion from 0.01 to 100 g/m², preferably from 0.1 to 10 g/m², more preferably from 0.5 to 5 g/m² relative to the jet section.

Advantageously, the deactivating compositions (D1), (D2) and optionally (D3) if a deactivating composition (D3) is used, have the same type of formulation (for example liquids, or water-in-oil emulsions, or oil-in-water emulsions) and/or include solvents of the same nature, for example water, or an oil of the same kind, or a petroleum fraction.

The deactivating compositions (D1), (D2) and (D3) have different hollowing effects.

This different hollowing effect may be obtained by employing an identical surface setting retarder in the deactivating compositions, but at a different concentration (generally, the higher the surface setting retarder concentration in the deactivating composition, the greater is the hollowing effect).

This different hollowing effect may also be obtained by using deactivating compositions comprising surface-setting retarders of different natures and having different hollowing effects. Preferably, the deactivating compositions (D1), (D2) and optionally (D3) if a deactivating composition (D3) is used, then only differ in the nature of the retarder, and possibly in the nature of the possible additives.

The deactivating compositions (D1), (D2) and/or (D3) may optionally contain additives making it possible to improve their properties, wherein they are chosen from among fillers, opacifying agents, anti-foam agents, surfactants, agents and hardening agents, biocides, thickeners, pigments, wetting agents (to improve the regularity of application of the deactivating composition (D1) to the surface), plasticizers, film-forming agents, dispersants, viscosity regulating agents (especially for net deposition of the droplet during printing, without spreading or shrinking), anti-oxidizing agents (in particular to prevent decomposition of the surface-setting retarder, in particular in the event of forced local drying) or a mixture of these.

In particular, the deactivating composition may comprise a viscosity-regulating agent to control the rheological properties of the deactivating composition used in order to allow easy application by printing. Preferably, the deactivating composition (D1) and/or (D2) and/or (D3) has a Brookfield viscosity of less than 500 mPa·s measured at 20° C.

Preferably, these viscosity-regulating agents are present in the deactivating composition in a content not exceeding 15% by weight, and preferably not exceeding 10% by weight.

The deactivating composition may also comprise a hardening agent. The hardening agents are, in particular, chosen from among vegetable oils, animal oils or mineral oils such as those described above.

The hardening agents may also be chosen from among resins solubilized in a solvent as described in application FR 2 828 192, styrene-butadiene latices, aqueous emulsions of acrylic resin as described in patent application EP 1 661 874, paraffinic emulsions, and acrylic polymers. They may also be chosen from among emulsions of paraffin waxes (paraffins of petroleum, synthetic or vegetable origin).

In order to allow time for the operator to print the deactivating composition (D1) on part or all of a surface of the fresh hydraulic binder-based composition, it may be necessary to delay the setting of the hydraulic binder-based composition and/or to increase its workability or open time.

In the context of the present invention, the term “open time” is understood to mean the time during which the hydraulic binder-based composition may be manipulated, i.e. the time during which the spreading or settling of the cementitious composition is greater than 50% of the initial value, wherein this value is measured by the height of subsidence in the Abrams cone according to the French standard EN12350-2 (2012) or by the spreading of the Abrams cone according to the French standard EN12350-8 (2010).

The fresh hydraulic binder-based composition may thus advantageously have an open time of at least 30 minutes, preferably 30 minutes to 4 hours. The retardation of setting and/or the increase in its workability may be brought about by the use of a retarding and/or fluidifying additive in the fresh hydraulic binder-based composition. Thus, and advantageously, the fresh hydraulic binder-based composition may further comprise at least one retarding and/or fluidifying additive. The retarding and/or fluidifying additives may be any additive known to persons skilled in the art, and fulfilling this function.

In the context of the invention, the term “retarding additive” means a compound having the effect of delaying the setting of the composition based on hydraulic binder, i.e. to delay or inhibit the phenomena related to this action such as hydration phenomena, thereby inducing a later hardening of the composition. Such compounds are well known to persons skilled in the art. In general, a retarding additive delays the setting time of a hydraulic binder-based composition in which it has been introduced at a dosage of at most 5% by dry weight relative to the weight of the hydraulic binder, wherein the time taken is measured according to the EN480-2 (2006) test. Preferably, the setting time is delayed by at least 30 minutes with respect to a control hydraulic binder-based composition.

In the context of the invention the term “fluidizing additive”, also referred to as “water-reducing additive”, means an additive intended to reduce the amount of water required for the production of a hydraulic binder-based composition.

The retarding and/or fluidifying additive may be chosen from the family of comb-structure polymers, compounds comprising a polyalkoxylated chain and at least one amino-alkylene phosphonic group, gluconic acid, sugars, lignosulfonic acid, polynaphthalene sulfonic acid, polymelamine sulfonic acid and salts thereof, alone or in admixture.

The comb structure polymers are chosen, in particular, from polycarboxylate main chain comb copolymers bearing grafted side chains of polyalkylene oxide (or PCP).

The compounds comprising a polyalkoxylated chain and at least one amino-alkylene phosphonic group may be chosen from the compounds of formula (I):

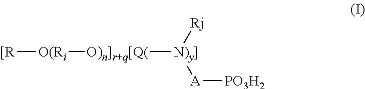

in which:

R is a hydrogen atom or a monovalent hydrocarbon group having from 1 to 18 carbon atoms and optionally one or more heteroatoms;

the Rᵢ are the same or different from each other and represent an alkylene such as ethylene, propylene, butylene, amylene, octylene or cyclohexene, or an arylene such as styrene or methylstyrene, the Rᵢ optionally contain one or several heteroatoms;

Q is a hydrocarbon group having 2 to 18 carbon atoms and optionally one or more heteroatoms;

A is an alkylidene group having 1 to 5 carbon atoms;

the Rⱼ are similar or different from each other and may be chosen from:
the group A-PO₃H₂, wherein A has the meaning mentioned above,
the alkyl group comprising from 1 to 18 carbon atoms and capable of bearing [R—O(Ri-O)ₙ], wherein R and Rᵢ have the abovementioned meanings,
and the group

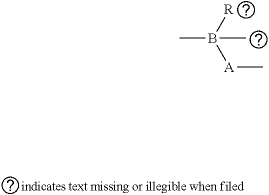

in which:

Rk denotes a group such as Rⱼ, while Rₖ is preferably chosen from an A-PO₃H₂ group, A has the meaning mentioned above; and an alkyl group with from 1 to 18 carbon atoms and capable of bearing [R—O(Rᵢ—O)ₙ], while R and Rᵢ have the abovementioned meanings;

B denotes an alkylene group containing from 2 to 18 carbon atoms,

“n” is a number greater than or equal to 0,

“r” is the number of [R—O(Rᵢ—O)ₙ] groups borne by the set of Rⱼ,

“q” is the number of [R—O(Rᵢ—O)ₙ] groups borne by Q, the sum

“r+q” is between 1 to 10,

“y” is an integer between 1 to 3,

Q, N and Rⱼ may together form one or more rings, which ring(s) may further contain one or more other heteroatoms.

Particularly preferred is a polyalkoxylated polyphosphonate consisting of a water-soluble or water-dispersible organic compound having at least one amino-di-(alkylene-phosphonic) group and at least one polyoxyalkylated chain or at least one of its salts. In particular, the compounds of formula (I) in which R is a methyl group, the Rᵢ are ethylene and propylene groups, while r+q is 1 as it is not between 30 and 50, Q is an ethylene group, A is a methylene group, y is 1 and Rⱼ corresponds to the CH2-PO₃H₂ group.

Such compounds are described, in particular, in application EP 0 663 892. Preferably, this compound is in particular contained in the CHRYSO® Fluid Optima 100 product available from CHRYSO.

A particular example of a retarding and/or fluidizing additive contained in the products CHRYSO® Fluid Optima 100 and CHRYSO® Fluid Optima 175 available from the company CHRYSO may be mentioned.

The sugars may be selected from among glucose, fructose, sucrose, meritose, lactose, maltotriose, dextrose, maltose, galactose, mannose, glycogen, or a mixture thereof.

The retarding and/or fluidizing additive may preferably be chosen from polycarboxylate main chain comb copolymers bearing polyalkylene oxide (or PCP) grafted side chains or the compounds of formula (I), or their mixture.

Preferably, the content of retarding and/or fluidifying additive in the fresh hydraulic binder-based composition is from 0.2 to 3% by dry weight relative to the weight of fresh hydraulic binder.

After the deactivating composition (D1) is printed on part or all of a surface of the fresh hydraulic binder-based composition, the method generally comprises a step of hardening the fresh hydraulic binder-based composition, followed by a step of removing the unhardened of the hydraulic binder layer on the surface. This last step makes it possible to reveal the aggregates on the surface of the hydraulic binder-based composition and to cause the pattern appear. It is typically carried out by rinsing with a water jet, generally under high pressure, or by brushing. The hardening step of the fresh hydraulic binder-based composition generally lasts from 8 to 24 hours.

According to a second alternative, the method comprises application by printing an acidic composition (A1) on part or all of a surface of a hardened hydraulic binder-based composition.

The method according to the invention generally comprises, before the step of the application by printing the acidic composition (A1) on the hardened hydraulic binder-based composition, a step of shaping a fresh hydraulic binder-based composition, followed by a step of hardening the fresh hydraulic binder-based composition to obtain the hardened hydraulic binder composition. The shaping of the fresh hydraulic binder-based composition may be carried out by pouring, trowelling and, if necessary, by vibration, or by 3D printing (by an additive manufacturing method).

Different levels of hollowing may be desired for a given pattern. Two embodiments of this second alternative of the method are conceivable to obtain this effect.

According to a first embodiment, the method comprises applying by printing an acidic composition (A1) on part or all of a surface of a composition based on hardened hydraulic binder, then another printing application of the acidic composition (A1) on a part of the surface on which the acidic composition (A1) has been applied, wherein this other application may possibly be repeated. This first embodiment makes it possible to apply different amounts of acidic composition (A1) to different parts of the surface of the hardened hydraulic binder-based composition which it is desired to deactivate. Typically, successive passes of the printhead of the printer are effected on the part(s) of the surface for which a deeper hollowing is desired. The higher the amount of acidic composition (A1), the deeper will be the resulting hollowing. Thus, to obtain a pattern with two levels of deactivation, the acidic composition (A1) is applied once to a first part of the surface, and more than once (typically twice) to a second part of the surface. Similarly, to obtain a pattern with three levels of deactivation, the acidic composition (A1) is applied, for example, once to a first part of the surface, twice to a second part of the surface, and three times to a third part of the surface.

In this first embodiment, the method may comprise, between two successive applications of acidic composition (A1), an accelerated drying step of the part of the surface on which the other application will be carried out. This drying may be carried out under UV or infrared light. It allows faster preparation and a sharper outline of the various levels of the pattern.

According to a second embodiment, the method comprises applying by printing an acidic composition (A1) on part or all of a surface of a cured hydraulic binder-based composition, and then applying by printing an acidic composition (A2) to a part or the entire surface of the hardened hydraulic binder-based composition, wherein the (A1) and (A2) acidic compositions have different hollowing effects and are not applied to identical surfaces.

Of course, the fact that the acidic compositions (A1) and (A2) are not applied to identical surfaces does not exclude the surface on which the acidic composition (A1) is applied from being included in the surface on which the acidic composition (A2) is applied, or vice versa. In addition, the fact that the acidic compositions (A1) and (A2) are not applied to identical surfaces does not exclude the acidic compositions (A1) and (A2) from being applied to overlapping surfaces. When the surfaces overlap, a pattern with three levels of deactivation will be obtained: a first portion of the pattern with a first level of hollowing to which only the acidic composition (A1) has been applied, a second portion of the pattern with a second level of hollowing to which only the acidic composition (A2) has been applied, and a third portion of the pattern with a third level of hollowing to which the acidic compositions (A1) and (A2) have been applied.

Of course, as many different hollowing acidic compositions may be used as desired. Thus, in one embodiment of this second embodiment, the method comprises applying by printing an acidic composition (A1) on part or all of a surface of a hardened hydraulic binder-based composition, then applying by printing an acidic composition (A2) on part or all of the surface of the hardened hydraulic binder-based composition, and then applying by printing a composition of acid (A3) on part or all of the surface of the hardened hydraulic binder-based composition, wherein it is to be understood that the (A1), (A2) and (A3) acidic compositions have different hollowing effects and are not applied to identical surfaces.

Typically, each acidic composition (A1), (A2) and (A3) corresponds to the ink of an ink cartridge of the printer.

The acidic compositions (A1), (A2) and (A3) comprise an acid. They may be in the form of a solution in an aqueous or oily solvent or in a petroleum fraction, or in the form of a dispersion in an aqueous or oily solvent or in a petroleum fraction, in particular in the form of a suspension or in the form of an emulsion. Advantageously, the acidic compositions (A1), (A2) and optionally (A3) if an acidic composition (A3) is used, have the same type of formulation (for example, liquids or water-in-oil emulsions or oil-in-water emulsions) and/or comprise solvents of the same kind, for example water, or an oil of the same kind, or a petroleum fraction. Typically, each acidic composition (A1), (A2) and (A3) is an aqueous solution of one or more acids.

As part of this disclosure, the term “acid” means a compound whose pKₐ at 25° C. is less than or equal to 6.

The acid may be an acid of the:
inorganic type, preferably selected from hydrochloric acid (also called muriatic acid), sulfamic acid (HOSO₂NH₂), phosphoric acid and nitric acid,
organic type, preferably a carboxylic acid, an amino acid hydrochloride, preferably glycine hydrochloride (HOOC—CH₂—NH₃⁺, ⁻Cl), or an alkylsulfonic acid, preferably methanesulfonic acid.

The acid may be a strong acid (hydrochloric acid, sulphamic acid, nitric acid, methanesulphonic acid) or weak acid (phosphoric acid, carboxylic acid, glycine hydrochloride).

The acidic composition may comprise a mixture of several acids.

The acidic composition may comprise, for example, the composition consisting essentially of glycine hydrochloride as described in WO 2012/075091A2, as glycine hydrochloride acid.

The carboxylic acid may comprise a saturated or unsaturated carbon chain, preferably from 1 to 6 carbon atoms, for example from 1 to 3 carbon atoms (the carbon of the COOH of the carboxylic acid not being counted). It may comprise one, two or three carboxylic acid groups. The carboxylic acid may be a hydroxycarboxylic acid, which typically comprises one, two, three or more hydroxyl groups. Preferably, the pKₐ (or one of the pKₐ) of the carboxylic acid is from 2 to 6. It may be chosen, in particular, from the group consisting of glycolic acid, citric acid, tartaric acid, malic acid, lactic acid, acetic acid and mixtures thereof. Citric acid, tartaric acid and malic acid are preferred.

The acidic composition (A1), (A2) or (A3) generally comprises from 1 to 50% by weight of acid. Typically, when an ink jet printer is used, the proportions of acid in the acidic composition (A1), (A2) or (A3) are adapted so that the acid is in a proportion of 0, 0.1 to 500 g/m², preferably from 0.1 to 100 g/m², more preferably from 0.5 to 50 g/m² relative to the jet section.

The acidic compositions (A1), (A2) and (A3) have different hollowing effects.

This different hollowing effect may be obtained by using an identical acid in the acidic compositions, but at a different concentration (generally, the higher the acid concentration in the acidic composition, the higher is its hollowing effect). Typically, the lower the pH of the acidic composition, the greater is the hollowing effect.

This different hollowing effect may also be obtained by using acidic compositions comprising acids of different kinds and having different hollowing effects. Preferably, the acidic compositions (A1), (A2) and optionally (A3) if an acidic composition (A3) is used, differ only in the nature of the acid, and possibly in the nature of the possible additives. For example, a strong acid (A1) is used to effect the portion of the pattern with the deepest hollowing, while a weak acid (A2) is used to effect the part of the pattern with the shallower hollowing.

The acidic compositions (A1), (A2) and/or (A3) may optionally contain additives making it possible to improve their properties and that are chosen from among fillers, opacifying agents, anti-foam agents, surfactants, biocides, thickeners, pigments, wetting agents (to improve the regularity of application of the acidic composition (A1) to the surface), plasticizers, film-forming agents, dispersants, viscosity (in particular for a net deposition of the droplet during printing, without spreading or shrinking), antioxidants (in particular to prevent the decomposition of the acid, in particular in the event of forced local drying), or a mixture of these.

In particular, the acidic composition may comprise a viscosity regulating agent to control the rheological properties of the acidic composition used in order to allow easy application by printing. Preferably, the acidic composition (A1) and/or (A2) and/or (A3) has a Brookfield dynamic viscosity of less than 500 mPa·s measured at 20° C.

Preferably, these viscosity regulating agents are present in the acidic composition at levels not exceeding 15% by weight, and preferably not exceeding 10% by weight.

In particular, the acidic composition may comprise an antifoaming agent to control the foam generated upon application of the acid. This antifoaming agent may be based on oil, siloxane, silicone or alkoxylated fatty alcohols.

After application by printing of the acidic composition (A1) on part or all of a surface of the hardened hydraulic binder-based composition, the method generally comprises a step of rinsing the hardened hydraulic binder-based composition. Rinsing makes it possible to eliminate the acid and also the deposits of hydraulic binder-based composition which have been etched on the surface and which makes visible the aggregates on the surface of the hydraulic binder-based composition and thus the pattern. It is typically effected by rinsing with a water jet, preferably under high pressure. Generally, one waits a few minutes, typically between 5 and 60 minutes before rinsing, so that the acidic composition has time to etch the surface of the hydraulic binder-based composition.

As detailed above, whichever the alternative method used, the desired hollowing may be obtained by adapting:
the diameter of the jet (or droplets) of the ink jet printer (the larger the diameter, the greater the amount of deactivating composition (D1) or acid (A1) applied, and the greater is the hollowing), and/or
the hollowing effect of the deactivating composition (D1) or acidic composition (A1), by adapting:
   the nature of the surface-setting retarder in the deactivating composition (D1) or the nature of the acid in the acidic composition (A1), and/or
   the concentration of the surface-setting retarder in the deactivating composition (D1) or the concentration of the acid in the acidic composition (A1) (and therefore its pH).

The surface of the hydraulic binder-based composition may have different hollowing effects as a function of the location. A hollowing is understood to refer to a given area of the surface of the hydraulic binder-based composition.

The patterns may, in particular, be created by making the aggregates (or some aggregates) of the hydraulic binder-based composition visible. The amount of deactivating composition (D1) or acid (A1) applied and/or the hollowing effect of the deactivating composition (D1) or acid (A1) are/is then adapted so that at least one of the hollowing effects is less than the lower dimension of the aggregate of the hydraulic binder-based composition that is to be made visible, wherein the smaller size of the aggregate is measured by sieve analysis.

The amount of deactivating composition (D1) or acidic composition (A1) applied may be adjusted by adapting the size of the jet/droplets of the printer and/or by making successive passes of the print head of the printer as described above.

In fact, if the hollowing is greater than the size of the aggregate of the hydraulic binder-based composition that it is desired to make visible, the granulate is removed from the hydraulic binder-based composition during rinsing, which is not desired. Typically, the amount of deactivating composition (D1) or acidic composition (A1) applied and/or the hollowing effect of the deactivating composition (D1) or acidic composition (A1) are/is adapted so that at least one of the hollowing effects is at least twice as small, in particular at least 5 times smaller, for example at least 10 times smaller, than the lower dimension of the aggregate of the hydraulic binder-based composition that is to be made visible, where the lower dimension of the aggregate is measured by sieve analysis.

By way of illustration, if it is desired to make a granulometric fraction of the aggregates of the hydraulic binder-based composition visible, the desired hollowing is less than the lower dimension of this granulometric fraction of the aggregates of the hydraulic binder-based composition, wherein the smaller size of the granulometric distribution of aggregates is measured by sieve analysis. Typically, the hollowing is at least 2 times smaller, in particular at least 5 times smaller, for example, at least 10 times smaller than the lower dimension of the finest aggregates of the hydraulic binder-based composition. For example, it is desired to make visible the aggregates larger than 1 mm of a hydraulic binder-based composition prepared from the standardized sand of the company SNL. The particle size distribution of this sand where the diameters are measured by sieves is given in Table 1:

TABLE 1
Particle size distribution of standardized sand from SNL

| Sieve mesh size (mm) (%) | Cumulative refusal (%) |
|---|---|
| 0.08 | 99 ± 1 |
| 0.16 | 87 ± 5 |
| 0.50 | 67 ± 5 |
| 1.00 | 33 ± 5 |
| 1.60 | 7 ± 5 |
| 2.00 | 0 |

In this example, hollowing less than or equal to 10 times 1 mm, or less than or equal to 100 μm would therefore be particularly preferred.

The patterns may also be created by placing the hydraulic binder-based composition on a different color substrate.

In one embodiment, the hydraulic binder-based composition is on a substrate with a color that is different from that of the hydraulic binder-based composition, and the amount of deactivating composition (D1) or acidic composition (A1) applied, and/or the hollowing effect of the deactivating composition (D1) or acidic composition (A1) are/is adapted so that at least one of the hollowing effects is greater than or equal to the thickness of the hydraulic binder-based composition.

By “thickness of the hydraulic binder-based composition” is meant the distance between the surface of the substrate on which the hydraulic binder-based composition is placed and the surface of the hydraulic binder-based composition.

When the hollowing effect is greater than or equal to the thickness of the hydraulic binder-based composition, the hydraulic binder-based composition is removed in a localized manner throughout its thickness to the substrate. After rinsing, the surface portions to which the deactivating composition (D1) or acidic composition (A1) has been applied form patterns, whose color will be that of the substrate, while the remainder of the surface will be of the color of the hydraulic binder-based composition.

The substrate may, in particular, be a second hydraulic binder-based composition, the color of which is different from that of the hydraulic binder-based composition to which the deactivating composition (D1) or acidic composition (A1) is applied. It is usual to introduce one or more pigments in a hydraulic binder-based composition to give it a desired color. For example, a dark gray concrete (as a substrate) may be coated with a fresh gray hydraulic binder-based composition to a thickness of 1 to 5 mm, and then applied by printing a deactivating composition (D1) on a portion of the surface of the fresh gray hydraulic binder-based composition, so that the hollowing effect is greater than or equal to the thickness of the fresh hydraulic binder-based composition. After rinsing, the surface portions to which the deactivating composition (D1) has been applied will form dark gray patterns, while the remainder of the surface will be light gray.

It is sufficient if at least one of the hollowing effects is greater than or equal to the thickness of the hydraulic binder-based composition. For example, there may be two different hollowing effects as a function of the locations of the surface of the hydraulic binder-based composition:
in certain parts of the surface, a first hollowing effect may be greater than or equal to the thickness of the hydraulic binder-based composition in order to make the substrate (and therefore its color) visible, and
at other locations on the surface, a second hollowing effect is less than the lower dimension of the aggregates of the hydraulic binder-based composition that is to be made visible (and therefore less than the thickness of the hydraulic binder-based composition), in order to make visible the aggregates of the hydraulic binder-based composition.

Using the previous example in which a dark gray concrete (as a substrate) of a fresh hydraulic binder-based composition is covered by a light gray color, with two different hollowing effects according to the locations of the surface of the fresh hydraulic binder-based composition:
in some parts of the surface, a first hollowing effect greater than or equal to the thickness of the hydraulic binder-based composition, makes visible dark gray patterns after rinsing,
at other locations on the surface, a second hollowing effect less than the lower dimension of the aggregates of the hydraulic binder-based composition that is to be made visible, makes it possible to form light gray patterns in which the aggregates of the hydraulic binder-based composition are visible,
if there are other areas of the surface where no deactivating composition has been applied, the surface is light gray and the aggregates are not visible.

In one embodiment of the method, both alternatives are implemented one after the other. The method then comprises:
the application by printing of a deactivating composition (D1) on part or all of the surface of a fresh hydraulic binder-based composition, then
the hardening of the fresh hydraulic binder-based composition, then
the elimination of the layer of unhardened hydraulic binder-based composition, and then
the application by printing of an acidic composition (A1) on part or all of the surface of a hardened hydraulic binder-based composition.

The deactivating composition (D1) and the acidic composition (A1) may be applied to the same or different surface portions.

Whichever the alternative of the method used, the hydraulic binder-based composition may undergo, before or during the creation of the pattern, on all or part of its surface, an aesthetic treatment intended to protect it and/or to color it. It may for example, during the creation of the pattern on all or part of the surface, undergo a mineralizing treatment (or hardening), in particular to induce coloring. It may also, after creation of the pattern on all or part of its surface, be covered with a protective product. The protective product is typically applied to the hardened composition for the purpose of protecting it, in particular from external aggression. Such products are known to persons skilled in the art. The surface treated and/or covered may be both the surface of the areas intended to produce the pattern, and the surface of the areas having the pattern, as the surrounding areas.

The surface may also, after creating the patterns, undergo mechanical treatments known to persons skilled in the art such as polishing, sandblasting . . . .

1. A method of creating a pattern on a surface of a hydraulic binder-based composition, comprising printing of a deactivating composition or an acidic composition to a part of or all of a surface of a hydraulic binder-based composition.

2. The method according to claim 1, wherein the printing is performed by an ink jet printer whose print head expels droplets of the deactivating composition or the acidic composition.

3. The method according to claim 1, wherein the surface of the hydraulic binder-based composition is not flat, and the printing is implemented with a printer allowing control of the location of the printing of the deactivating composition or the acidic composition in three dimensions.

4. The method according to claim 1, wherein a deactivating composition is applied and the hydraulic binder-based composition is a fresh hydraulic binder-based composition.

5. The method according to claim 4, comprising a step of shaping the fresh hydraulic binder-based composition by a 3D printer, and a step of applying by the 3D printer of the deactivating composition on a part of the surface of the fresh hydraulic binder-based composition.

6. The method according to claim 4, comprising printing a deactivating composition on part of or all of a surface of a fresh hydraulic binder-based composition, followed by another printing of the deactivating composition on a part of the surface on which the deactivating composition has been applied, wherein this other application may possibly be repeated.

7. The method according to claim 4, comprising printing a first deactivating composition on part of or all of a surface of a fresh hydraulic binder-based composition, followed by printing a second deactivating composition on part of or all of the surface of the fresh hydraulic binder-based composition, wherein the first and second deactivating compositions have different hollowing effects and are not applied to identical surfaces.

8. The method according to claim 4, comprising, after the step of printing the deactivating composition, a step of hardening the fresh hydraulic binder-based composition, followed by a step of removing the unhardened hydraulic binder-based composition on the surface.

9. The method according to claim 1, wherein an acidic composition is applied and the hydraulic binder-based composition is a hardened hydraulic binder-based composition.

10. The method according to claim 9, comprising printing an acidic composition to part of or all of a surface of a hardened hydraulic binder-based composition, followed by another printing of the acidic composition on a part of the surface on which the acidic composition has already been applied, wherein this other application may possibly be repeated.

11. The method according to claim 9, comprising printing a first acidic composition to a part or the entire surface of a hardened hydraulic binder-based composition, and then printing a second acidic composition to a part of or the entire surface of the hardened hydraulic binder-based composition, wherein the first and second acidic compositions have different hollowing effects and are not applied to identical surfaces.

12. The method according to claim 9, comprising, after the step of printing the acidic composition, a step of rinsing the hardened hydraulic binder-based composition.

13. The method according to claim 1, wherein the amount of printed deactivating composition or of printed acidic composition and/or the hollowing effect of the deactivating composition or acidic composition are/is adapted so that at least one of the hollowing effects is less than the lower dimension of the aggregates of the hydraulic binder-based composition that is to be made visible, wherein the lower dimension of the aggregates is measured by granulometric sieve analysis.

14. The method according to claim 1, wherein the hydraulic binder-based composition is on a substrate whose color is different from that of the hydraulic binder-based composition, and the amount of printed deactivating composition or of printed acidic composition and/or the hollowing effect of the deactivating composition or acidic composition are/is adapted so that at least one of the hollowing effects is greater than or equal to the thickness of the hydraulic binder-based composition.

15. The method according to claim 1, wherein the hydraulic binder-based composition comprises a cement.

16. The method according to claim 8, wherein the removing of the unhardened hydraulic binder-based composition on the surface is carried out by high pressure water jet rinsing or brushing.
